(19) United States
(12) Patent Application Publication
(10) Pub. No.: US 2005/0086318 A1
(43) Pub. Date: Apr. 21, 2005

(54) Method for transmitting objects between a server and a client terminal using cache management, corresponding transmission, server and terminal

(75) Inventor: Olivier Aubault, Rennes (FR)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(73) Assignee: France Telecom, Paris (FR)

(21) Appl. No.: 10/499,254

(22) PCT Filed: Dec. 5, 2002
(86) PCT No.: PCT/FR02/04199

(30) Foreign Application Priority Data
Dec. 20, 2001 (FR) 01/16632

(51) Int. Cl. G06F 15/167; G06F 15/16

(52) U.S. Cl. 709/213; 709/203; 709/219

(57) ABSTRACT

The invention concerns a method for transmitting data, called objects, via at least a communication network, between a server and at least a client terminal, at least a cache memory, designed to store at least some of said objects transmitted by the server, being associated, in said network, with at least one of said client terminals. The invention is characterized in that it consists in managing, upstream of said client terminals, at least a list of objects present in said cache memory associated with at least one of said client terminals, so as to limit exchange of data concerning the content of said cache memory between said client terminal and said server.

The domain of the invention is data transmission through communication networks. More precisely, the invention relates to transmission of data to be displayed interactively, and corresponding cache management.

Extraordinary developments in communication networks now make it possible for users to display, for example, image, text, geometric type models or 3D scene type models, interactively and in real time. Conventionally, users connect to a remote server through an appropriate terminal, and this remote server centralises all information that the user needs for this display in a database (note that although the term “display” is used in this case, this type of information can comprise all types of data, and particularly sound data, paginated data, etc.).

Users can thus access new applications, for example of the type that enables them to move about in a 3D virtual environment such as a virtual museum, ground relief or a classical music concert. Therefore in the context of these applications, the server sends information necessary for reconstruction of the global scene to the client, together with information about different objects in the scene that enter the field of vision (or the field of hearing) of the user, depending on his position in the scene.

The invention is particularly, but not exclusively, applicable to such transmission and storage of all types of information accessible by the user through a data server, for example for future use.

In order to enable real time display (like that described above), for example of a scene or a video, the user's terminal is usually associated with a cache, in which all information necessary for the terminal to reproduce the scene in real time, is stored.

This type of cache conventionally memorises “past” data, in other words data that the terminal has already used to reproduce a scene or an image, but that could be used later possibly depending on the user's needs. It also stores “present” data, in other words data that the terminal is currently using, and finally possibly “future” data that may be necessary to the terminal in the near future, and that result from the server anticipating the user's needs.

As can easily be understood, firstly the volume of information that the server has to transmit, and secondly that has to be managed in the cache, is considerable, particularly if the user wants to display very large items of data, for example such as very large three-dimensional scenes.

Several methoding methods could be introduced in order to solve problems related to the large volume of data exchanges between the client and the corresponding server, and particularly:
a replacement algorithm that can be used to choose stored data to be deleted to release memory space, when the cache-filling ratio is high,
a transmission method that governs the choice made by the server of data to be sent to the client, and the transmission mode of these data.

At the moment, there are two main known transmission methods for creating a dialogue between the client and the server, and notifying the server about information to be transmitted to the client.

The first known transmission method is described particularly in the document “Multi-Resolution Model transmission in Distributed Virtual Environments” by J. H. P. Chim et al., VRST'98, p.25-34.

According to this first method, the server can send data that the client wants to display in four successive steps:
during a first step, the client terminal sends information to the server related to the user's position in the scene to be displayed;
when the server receives this position information, it calculates all the objects necessary for the user, and during a second step transmits the list of necessary <O, L₀> pairs of objects, where O is a reference of the object and L₀ is a detail level corresponding to it;
the client terminal then uses this list to choose couples corresponding to the objects that it wants to receive, as a function of the contents of its cache, and transmits the result of its choice to the server during a third step;
during a fourth step, the server transfers the objects requested by the client's terminal.

One disadvantage of this technique according to prior art is that every time that the user position changes in the scene, and therefore every time that the server has to send one or several new objects to the user, two complete data exchanges in the form of forward-return movements are necessary between the server and the client terminal, before the object(s) necessary become accessible to the user through its cache memory.

Therefore, this type of technique is not adapted to data transmission through communication networks that have long latency; for this type of network, this technique is incapable of enabling real time display of data transmitted by the server.

A second known transmission method is described in the article “On Caching and Prefetching of Virtual Objects in Distributed Virtual Environments” by J. H. P Chim et al., Proceedings of the sixth ACM international conference on Multimedia, 1998, pages 171-180.

According to this second method, which is more particularly adapted to transmission of progressively coded objects, the client terminal sends information to the server about each of its movements in the displayed scene, together with position information and information related to the contents of its cache, in the form of <O, L₀> pairs. Once again, O represents a reference of the object contained in the client cache, and L₀ informs the server about the detail level associated with this object.

The server then calculates all visually relevant objects as a function of the user's position in the scene, checks whether or not these objects are present in the user's cache, and transmits all missing objects to the client.

With this method, a single forward-return between the client and the server is necessary to transfer data necessary to display the scene to the client.

However, one disadvantage of this technique according to prior art is that it consumes very many network resources, particularly in terms of the pass band. For every user movement in the scene, the client terminal transfers all information about the contents of its cache to the server (in other words all <O, L₀> pairs corresponding to objects contained in its cache).

Therefore, in the case of a display of very large scenes, the quantity of information transmitted from the client terminal to the server is very high, and this is particularly problematic for low speed communication networks.

One particular purpose of the invention is to overcome disadvantages according to prior art.

More precisely, one purpose of the invention is to provide a technique for transmission of information necessary for the real time display of large volumes of data from a server to a client terminal, minimising transfers between the server and the client terminal.

Another purpose of the invention is to implement this type of data transmission technique that is simple and inexpensive to implement.

Another purpose of the invention is to supply such a data transmission technique through a communication network, adapted to any type of network, and in particular equally well to networks with high latency and to low speed networks.

Another purpose of the invention is to implement such a data transmission technique to avoid redundancies in data transmissions from the server to the client terminal.

Yet another purpose of the invention is to propose such a data transmission technique that eliminates, or at least reduces, data requests sent by the client terminal to the server.

These objectives, and others that will become clear later, are achieved by means of a method for the transmission of data, called objects, through at least one communication network between a server and at least one client terminal, at least one cache memory that will store at least some of the said objects transmitted by the said server being associated with at least one of the said client terminals within the said network.

According to the invention, at least one list of objects present in the said cache memory associated with one of the said client terminals is managed on the input side of the said client terminals, in order to limit information exchanges related to the contents of the said cache memory between the said client terminal and the said server.

Thus, the invention is based on a quite innovative and inventive approach to management of cache memories. The invention particularly depends on the innovative and advantageous idea of maintaining a list on the input side (upstream) of a client terminal accessible to the data server, representative of the contents of a cache associated with the client. Therefore, with this solution, the server can know the contents of the client cache at any time, without the need to duplicate these contents at the server. Therefore, the invention provides a solution that, although it is not expensive in terms of resources and particularly memory for the server, can considerably reduce the volume of information exchanged between the server and the client when the client displays a scene or a set of objects. This type of solution is particularly advantageous for low capacity client terminals, or for communication networks with limited performances.

Several techniques are already known, described particularly in patent documents U.S. Pat. No. 6,098,064 and U.S. Pat. No. 5,956,039, planning for management of object lists or documents lists in the context of exchanges between a server and a client terminal. However, these lists are very different from the list according to this invention, both in terms of forms and functions.

Thus, the patent document U.S. Pat. No. 6,098,064 describes a technique for determining what documents (particularly in the form of web pages) should be stored in the cache memory of a computer, as a function of the probability that these documents will be required by a user in the future. With this technique, a list of needs is drawn up listing documents present in the cache memory of the terminal, or that could interest a user in the future.

Unlike the list according to the invention, the function of the list mentioned above is not to reduce the number and/or the volume of information exchanged between the server and the client terminal when the client displays the documents, and it cannot be used for this purpose.

The patent document U.S. Pat. No. 5,956,039 presents a technique for improving the performances of a real time navigation system in a 3D scene. This type of technique consists of attributing priorities to different objects in the scene, such that the client terminal receives objects with the highest priority first. These priorities are managed within a database containing information about each object in the current scene.

However, this database is not managed on the input side (upstream) of the client terminal, and therefore cannot solve the technical problem of reducing exchanges between the server and the terminal, as this invention does.

Advantageously, an identifier for each of the said objects is stored within the said list, together with information about reproduction of the said object, for at least one of the said objects.

Therefore, the server can access not only the list of objects contained in the client cache, but also the reproduction level at which they can be reproduced by the client.

Preferably, the said reproduction information for at least one of the said objects relates to a refinement level of the said object.

Therefore, the server can know if the client terminal is capable of reproducing the object, for example in coarse or detailed form.

Preferably, the said list comprises a <O, L₀> pair for each of the said objects stored in the said cache memory, including the said O identifier of the said object and the said reproduction information L₀ of the said object.

According to one advantageous characteristic of the invention, at least one item of information about the said client terminal and/or a user of the said client terminal, called display information, is associated with the said list for each of the said client terminals, so as to form a context.

For each client connected to the server, the server manages a context including a representative list of the state of the cache associated with the client, and display information. This type of information may in particular be representative of the capacity of the client terminal, or its methoding speed.

Preferably, the said display information belongs to the group including:
position information of the said user;
observation direction of the said user;
selection parameters of the said objects.

For example, this type of selection parameters comprises an object selection threshold, and an observer view angle. In the case of the display of a 3D scene by the client terminal, the position information may be expressed in the form of a 3D point, for which the coordinates correspond to the position of the observer with respect to the centre of the scene. The observation direction may be expressed in the form of a 3D vector.

Advantageously, the said list is managed by the said server or by an intermediate element of the said network.

For example, the list may be managed by a proxy server, intermediate between the server and the client. The server can then send requests to the proxy, to determine the state of the contents of the client cache. The performance of this solution is much lower in that it generates more information exchanges, but it may be interesting in the case in which the server and the proxy are connected by a high performance network, and in which it is required to “relieve” the server (for example if the server has a low capacity).

According to one preferred embodiment of the invention, this type of method comprises a preliminary initialisation phase involving a first transmission step for each of the said client terminals in which initial display information is transmitted to the said server, and a storage step in which the said server stores the said initial display information in the said corresponding context.

Advantageously, the said preliminary initialisation phase also comprises a second transmission step in which the said server makes a transmission to the said client terminal, to send a coarse version of the scene to be reproduced by the said client terminal.

Therefore according to the invention, and unlike solutions according to prior art, not all of the database containing the objects that the client would like to display is transmitted on initialisation, which results in a considerable saving in terms of memory for the client and network passband. Consider a database with about 100 Mbits, and let us consider that the client and the server are connected by an ADSL “Asymmetric Digital Subscriber Line” type network with a maximum speed of 500 kbits/s. Therefore, when the connection between the client and the server is initialised, the entire base necessary to load the entire scene to be displayed at the client is transmitted, requiring at least 200 s. The invention eliminates the need for this transmission on initialisation, and is therefore particularly advantageous for the client since it means that he can display at least a coarse representation of the scene almost instantaneously, thus eliminating the long waiting of at least 200 s, which is more than three minutes, imposed by techniques according to prior art.

Preferably, each of the said client terminals implements a step to transfer at least some of the said items of display information to the said server at predetermined time intervals and/or when the said display information is modified.

It will be noted that the choice consisting of transferring display information at predetermined time intervals minimises the number of transmissions, if information has been modified since its last transmission.

According to a first advantageous embodiment of the invention, the said predetermined time intervals are fixed by the said client terminal.

In particular, they may be forced by the client, for example as a function of the frequency at which the client wants to have the scene to be displayed refreshed.

According to a second advantageous embodiment of the invention, the said predetermined time intervals depend on at least one characteristic of the said communication network.

In particular, these time intervals may depend on the network load, or for example its throughput or its latency time.

Preferably, at the end of the said transfer step done by the said client terminal, the said method implements a step to update the said display information within the corresponding said context.

Advantageously, at the end of this update step, the said server implements the following steps:
a determination step, as a function of at least some of the said updated display information, to determine at least one identifier object O necessary to the said client terminal, and a corresponding reproduction level L₀;
a step to analyse the said list representative of the said cache memory associated with the said client terminal, so as to identify pairs <O, L₀>, if any, corresponding to the said identifier object(s) 0 and with reproduction level L₀ necessary to the said client terminal, and not memorised in the said list;
a step to transmit the said identifier object(s) O with reproduction level L₀, if any, that the said client terminal needs, corresponding to any of the said pair(s) <O, L₀> not memorised in the said list, to the said client terminal;
a step to update the said list representative of the said cache memory associated with the said client terminal, adding the said pair(s) <O, L₀> corresponding to the said object(s) sent, if any, to the said client terminal.

The step to determine one or several objects necessary for the client may be the result of a calculation carried out by the server as a function of information stored in the client context. This type of calculation can also be done by an independent calculation entity associated with the server, for example before the client connection is made; the determination step then consists of the server viewing the results of this calculation so as to identify the object(s) that it needs as a function of display information associated with the client. Therefore, compared with techniques according to prior art, the invention provides a means of transferring the calculation of objects necessary to the client, from the client's terminal to the server, or to the calculation entity associated with it.

Advantageously, the said server can also use:
a step to determine at least one identifier object O with reproduction level L₀ that may be necessary to the said client terminal, according to at least one predetermined probability criterion;
a step in which the said at least one identifier object O with reproduction level L₀ is sent to the said client terminal in anticipation.

For example, the server evaluates the probability that the observer is moving towards an object in the scene, as a function of the variation of its previous displacements, and if this probability is greater than a predetermined threshold, the server takes the initiative of sending an object that the client will need in the near future if he actually continues moving in the same direction.

Preferably, on reception of at least one object sent by the said server, the said client terminal performs the following steps:
a step for storage of the said received object in the said cache memory if the filling ratio of the said cache memory associated with the said client terminal is less than a predetermined threshold;
otherwise, a step for evaluation of a relevance criterion for the said received object:
if at least one of the said objects stored in the said cache memory has a relevance criterion with a value less than the said relevance criterion of the said received object, the said client terminal implements a sub-step to delete the said less relevant object from the said cache memory and a sub-step for storage of the said received object in the said cache memory;
otherwise, the said client terminal implements a sub-step to reject the said received object.

For example such a relevance criterion might depend on the distance from the object to the observer.

According to one advantageous characteristic of the invention, after the said elimination sub-step and/or the said rejection sub-step, the said client terminal sends at least one item of information to update the said cache memory associated with the said client terminal to the said server, so that the said server eliminates at least one <O, L₀> pair corresponding to the said object deleted during the said deletion sub-step, and/or an object sent by the said server during the said transmission step, but not memorised in the said cache memory, from the said list representative of the said cache memory.

Preferably, at least some of the said objects comprise at least one index, so as to be able to selectively transmit a portion of the said object starting from the said associated index.

In particular, these objects may for example be one of the following types:
2D images;
meshes;
textures;
sounds;
geometric models;
3D scenes;
video data;
aginated data.

It is obvious that this list is not exhaustive, and is only for illustrative purposes.

The invention also relates to a system for transmission of data, called objects, through at least one communication network between a server and at least one client terminal, at least one cache memory, designed to store at least some of the said objects transmitted by the said server, being associated with at least one of the said client terminals within the said network.

According to the invention, this type of system may comprise management means on the input side of the said client terminals, for management of at least one list of objects present in the said cache memory associated with one of the said client terminals, in order to limit information exchanges concerning the contents of the said cache memory between the said client terminal and the said server.

The invention also relates to a data server, for data called objects, connected through at least one communication network to at least one client terminal, at least one cache memory, provided to store at least some of the said objects transmitted by the said server, being associated with at least one of the said client terminals within the said network. This type of server comprises means of management of at least one list of objects present in the said cache memory associated with at least one of the said client terminals, in order to limit information exchanges with the said associated client terminal, for information related to the contents of the said cache memory.

The invention also relates to a client terminal for a data server like that described above, comprising means of transmission of at least one item of update information to the said server so as to enable the said server to update the said representative list of the said cache memory associated with the said terminal.

Other characteristics and advantages of the invention will become clearer after reading the following description of a preferred embodiment, given simply as an illustrative and non-limitative example, and the attached drawings, among which:

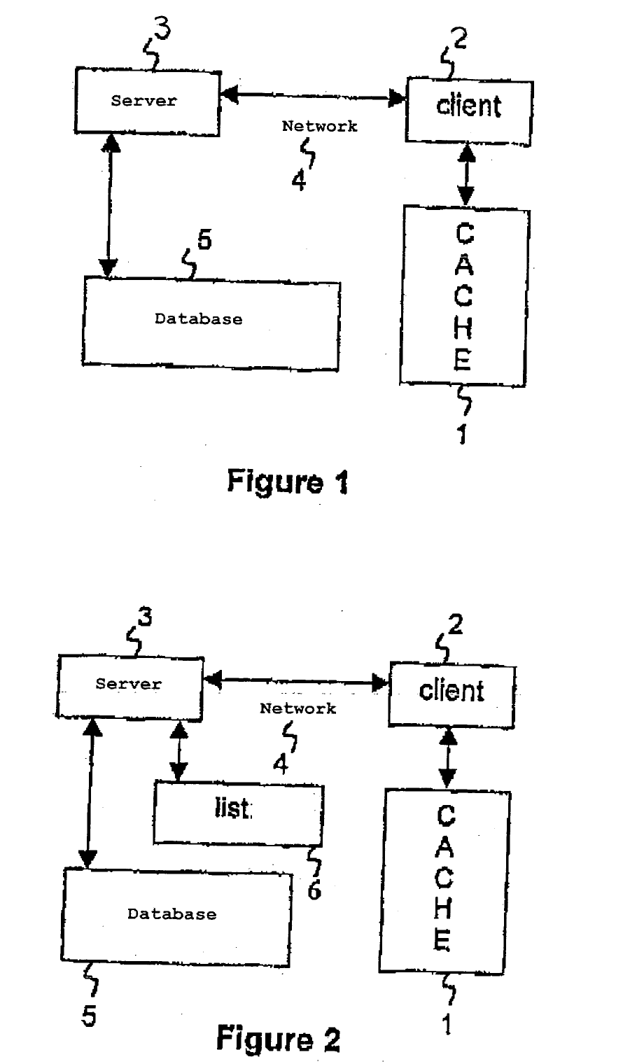

FIG. 1 presents a block diagram of a client-server architecture adapted to implementation of the invention;

FIG. 2 illustrates the architecture in FIG. 1, completed according to the invention by the addition of an object list management block, at the server;

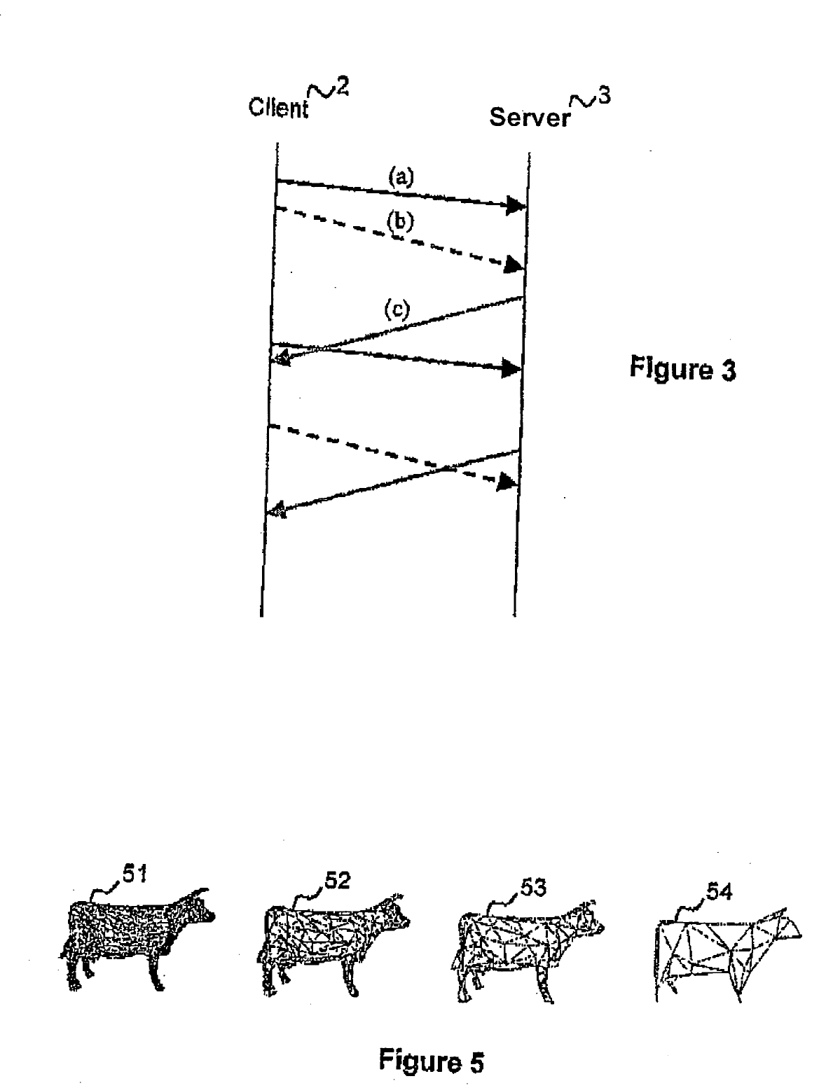

FIG. 3 illustrates an example of a client-server dialogue used according to the invention;

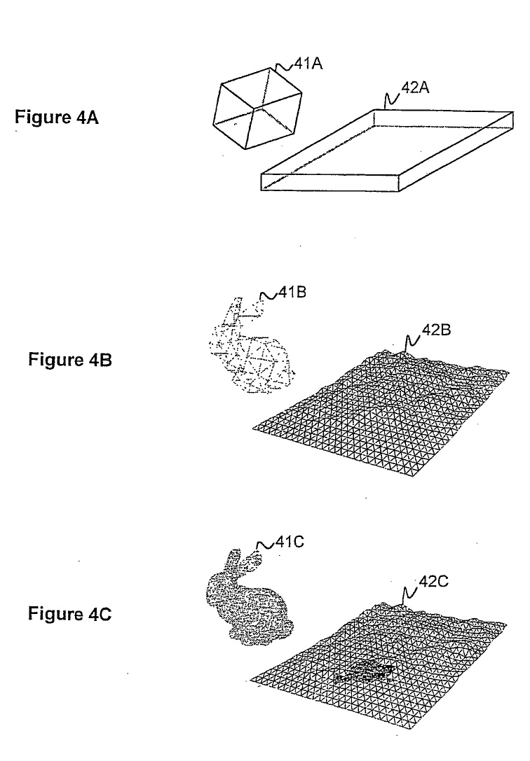

FIGS. 4a to 4c show an example embodiment of the invention within the context of 3D models coded by geometric wavelets;

FIG. 5 illustrates a second example of an embodiment of the invention for objects using non-progressive detail levels;

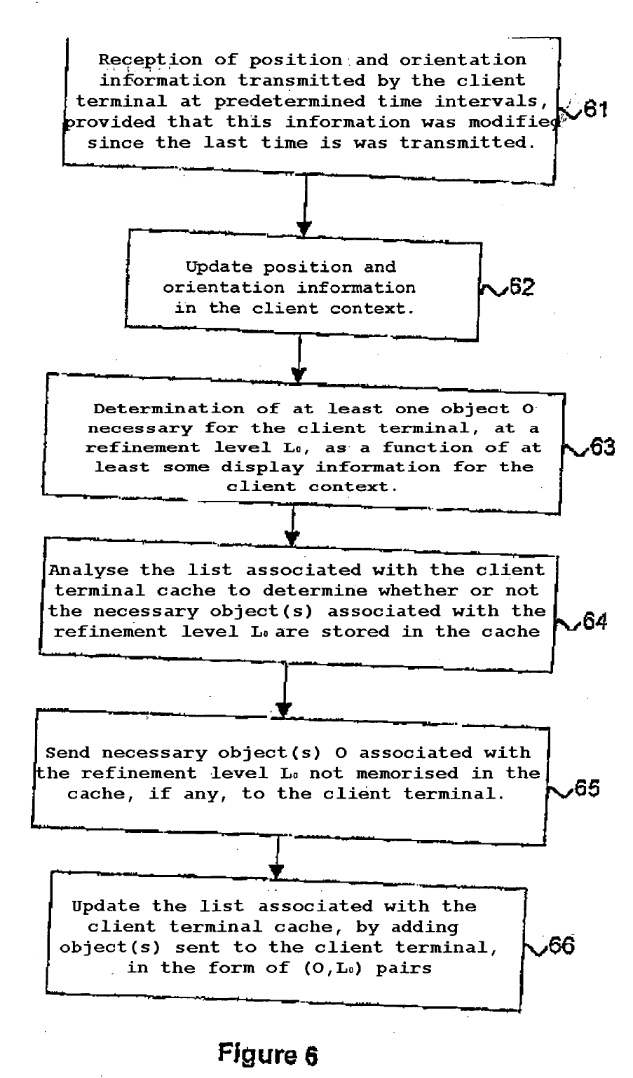

FIG. 6 shows a block diagram of the different steps used by the server according to the invention in a display phase;

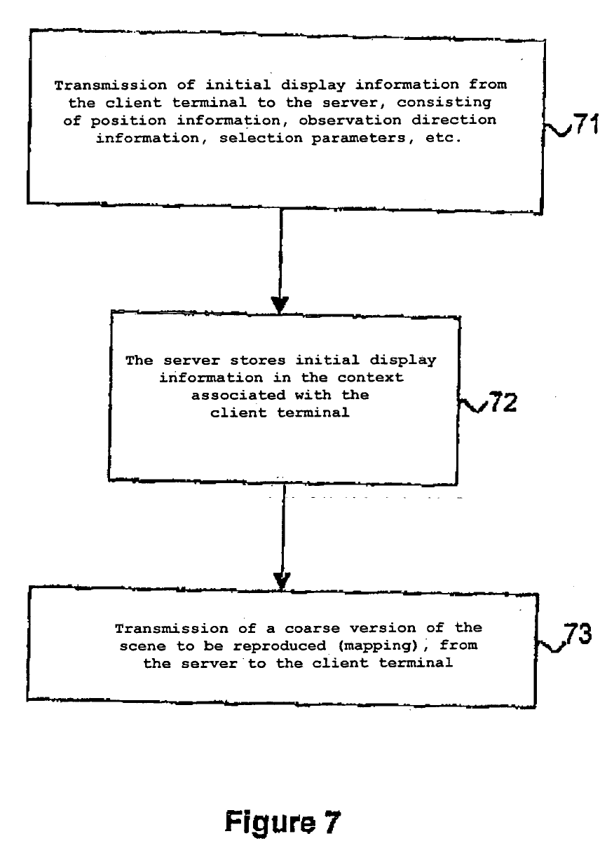

FIG. 7 describes the different steps used according to the invention in an initialisation phase;

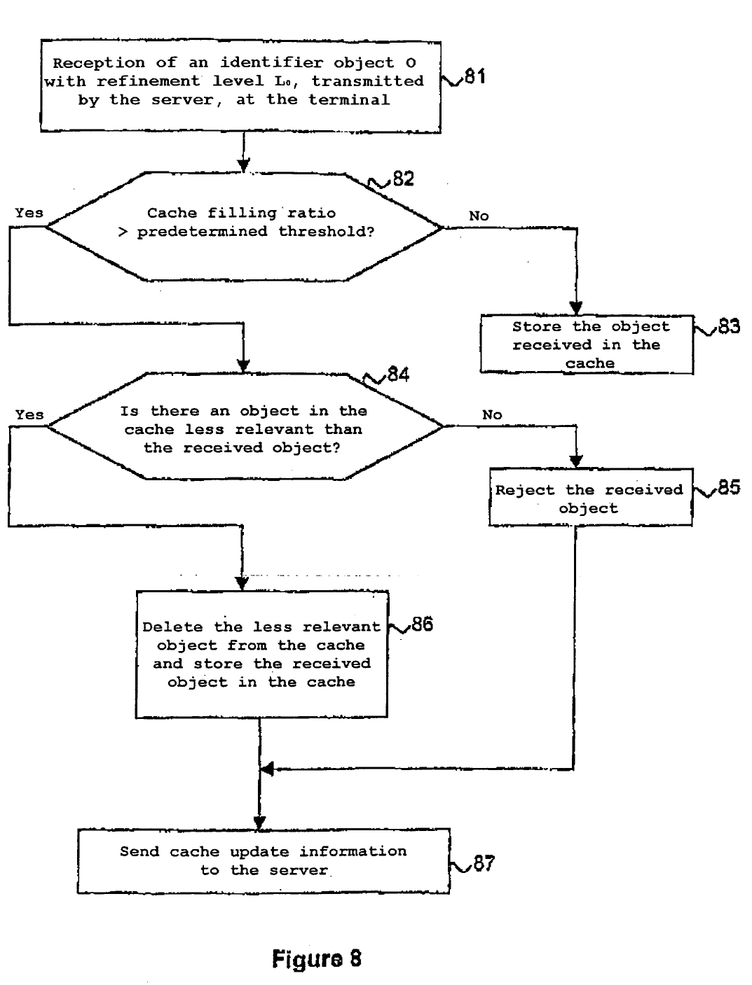

FIG. 8 shows a block diagram of the different steps used according to the invention during reception of an object by the client terminal.

The general principle of the invention is based on the management of a list of objects present in the cache memory associated with this terminal, on the input side of a client terminal (upstream), so as to reduce information exchanges between a server, to which the client terminal addresses object requests, and the client terminal itself.

The remainder of the document describes a particular application of the invention to progressive data transmission through a communication network, for a real time display of a scene by the client. (Remember that this invention is not limited to the display of objects, but can be applied to listening to sound objects, etc.).

We will describe an example network architecture that could be used within the context of the invention, with reference to FIG. 1.

This type of network architecture is a client-server architecture. A cache 1 is associated with the client 2; this cache 1 enables it to store data transmitted by a server 3 through a communication network 4.

Data stored in the cache 1 may be “present” data (in other words in use by the client terminal 2), or “future” data (in other words planned for later use) or “past” data (in other words previously used but now at least temporarily obsolete).

The cache 1 may be integrated into the client terminal 2, or it may simply be associated with the client terminal 2, while being located at another point in the network; for example, the cache 1 may be integrated into an intermediate server between the server 3 and the client 2, not shown in FIG. 1, and particularly a proxy type server. In one variant embodiment of the invention, the cache 1 may be shared by several clients 2. For simplification reasons, the remainder of the document is limited to describing a particular embodiment of the invention in which the cache 1 is integrated into the client terminal 2.

The client terminal 2 manages a set of information essential for the selection of objects to be displayed on its screen, as a function of their visibility, such as the position of the client in the scene to be displayed, the orientation of its observation, and selection parameters for objects to be displayed or to be reproduced, such as the object selection threshold, a view angle, etc.

The server 3 manages a database 5 in which a set of objects that the client 2 might want to display are grouped. These objects are preferably referenced within the database 5, by a single identifier, recognisable both by the server 3 and the client 2. For example, these objects may be 3D meshes, preferably with progressive transmission, sounds or other types of raw data. The database 5 may also contain several objects of different natures necessary for the reproduction of a scene by the client terminal 2; for example, if the client 2 would like to display a classical music concert, the database 5 may contain 3D objects to graphically reproduce the scene, and 3D sounds to reproduce sounds produced by music instruments.

According to one preferred embodiment of the invention, and as shown in FIG. 2, the server 3 also manages a list 6 that refers to the cache 1 of the client 2. According to one variant of the invention, this list 6 is not managed at the server 3, but on the input side of the client terminal 2, for example in a proxy server not shown in FIG. 2, intermediate between the client 2 and the server 3. For simplification reasons, in the remainder of this document we will simply describe the particular embodiment of the invention in which the list 6 is managed by the server 3, but starting from this description, a person skilled in the art could easily deduce the embodiment of the invention in the case in which the list 6 is managed outside the server 3, upstream the client terminal 2.

The list 6 is composed of a set of pairs <O, L₀>, where O is the object identifier, and L₀ corresponds to a reproduction level of the object considered, which was transferred to the client terminal 2. L₀ may be in several distinct forms depending on the type of object O used, as illustrated in the remainder of the document with reference to FIGS. 4 and 5.

The server 3 may also manage a set of information about the client terminal and/or the client 2, in association with the list 6, within a client context not shown in FIG. 2. For example, this information consists of the position of the client in the base associated with the scene to be displayed, the orientation of the client observation, and the selection parameters for objects to be displayed (particularly a selection threshold and a view angle for objects in the scene).

Within the context of the invention, the architecture presented in FIG. 2 can be used to transfer some calculations for selection of data to be displayed from the client terminal 2 to the server 3, which advantageously reduces exchanges between the client 2 and the server 3. This aspect of the invention will be described in more detail in the remainder of the document, with reference to FIG. 3.

In the context of the architecture in FIG. 2 and with reference to FIG. 7, we will describe the different steps involved during an initialisation phase of the dialogue between the server 3 and the client 2. Thus, some data are transmitted to initialise the server 3, when the client 2 is connected to the server 3.

During a step reference 71, the client terminal 2 transmits initial display information, for example such as the client position in the scene to be displayed, his orientation, the view angle or the object selection threshold, to the server 3 (particular as a function of the detail level that the client 2 would like to obtain). Note that the type of the selection threshold may vary as a function of the object type considered, as illustrated in the remainder of the document.

In a storage step 72, the server 3 stores the initial received display information in the context associated with the client terminal 2.

The server 3 can then transmit (73) a coarse version of the scene to be reproduced to the client terminal 2, in an operation also called mapping. This type of mapping corresponds to an elementary version of the database 5, and enables the client 2 to display at least a coarse view of the scene to be displayed on its terminal, at the beginning of the connection.

When the client 2 receives this map, it can in particular create different sub-caches necessary for the storage of data received from server 3, within the cache 1.

According to the invention, it is decided to store all objects of the same type received from the server 3, in the same sub-cache. If all objects in the scene to be displayed have the same nature, there is no need to create sub-caches within cache 1. In the particular example in which the client 2 displays a terrain relief on his terminal, it would be preferable to create a first sub-cache within cache 1 to store data related to the geometry of the terrain, and a second sub-cache designed to store the texture of the terrain.

After this type of initialisation phase, the client 2 and the server 3 can transmit and receive data from the base 5, for the client 2 to display the scene considered.

We will now describe the client-server dialogue during the display of the scene to be reproduced by client terminal 2, with reference to FIGS. 3 and 6.

The general principle of such a display phase is based on the client 2 transmitting information to the server 3, that the server 3 stores in the context associated with the client 2, and then uses to transmit data or objects necessary to continue displaying the scene, to the client 2.

This information is of different natures, and in particular it can be modified by the client 2 at different frequencies. Thus, the information about the client's position in the scene to be reproduced, and his direction of observation are modified as long as the scene is displayed, since the client 2, or more precisely the virtual observer associated with the client, moves about in the scene and looks around it.

Transmission of this information from the client 2 to the server 3 is symbolised by the arrow (a) shown in solid lines in FIG. 3. It is done at a frequency that can be defined by the client 2 (for example every 5 seconds) or it can be determined as a function of the capacities of the network 4 and the client terminal 2 (for example the frequency at which display information is transmitted may be fixed at 2 seconds for a high speed network, and 6 seconds for a low speed network). Transmission of this information (a) is also advantageously dependent on an event related criterion, in order to limit the number of exchanges (a) between the client 2 and the server 3: thus, the transmission (a) of position and observation direction information will not occur unless this information has been modified since the last time that it was transmitted (a) to the server 3.

For example, if the client 2 has moved in the scene since the last time that the position and observation direction information was transmitted (a) to the server 3, the modified information will be transmitted again 5 seconds later (if the transmission frequency is fixed at 5 seconds).

According to the invention, the client 2 does not wait for a response from the server 3 when transmitting (a), and this transmission can therefore take place in unconnected mode (for example of the UDP (User Datagram Protocol) type).

As shown in FIG. 6, when orientation and position information transmitted (a) by the client 2 is received 61, the server 3 updates 62 the context associated with the client 2, memorising the new received position and orientation information in the context.

Other information, such as selection parameters for objects to be transmitted, or cache 1 update information, is preferably transmitted according to an event-related criterion, namely modification of this information. This type of transmission from the client 2 to the server 3 is symbolised by the arrow (b) shown in dashed lines in FIG. 3. On reception, the server 3 stores this information either in the list 6 (for cache update information) or more generally in the context associated with the client 2.

Thus, update information for the cache 1 of the client 2 is transmitted to the server 3 in the form of a list of <O, L₀> pairs corresponding to objects present in the cache 1 (or in one of the sub-caches of cache 1) every time that:
one or several objects were deleted from the cache 1 by the client terminal 2 to store the new objects transmitted by the server 3; or
when one or several objects transmitted by the server 3 have been rejected by the client terminal 2.

These aspects will be described in more detail in the following with relation to FIG. 8, which illustrates the methoding done by the client terminal 2 following reception of objects transmitted by the server 3.

O represents an identifier of an object in the scene, and L₀ is information about the reproduction detail level of the object O. The structure of L₀ obviously depends on the object type O and the method used to code the associated detail levels. Thus, L₀ may be a value representative of the detail level (for example if the invention uses a HLOD “Hierarchical Level Of Detail” type technique), or a set of representative values coding geometric refinements of the object O, as illustrated in the following with reference to FIGS. 4 and 5.

Similarly, object selection parameters (such as the object selection threshold, the view angle, or any other information for modifying the selection of objects) will be transmitted when their value is modified. It would be possible to envisage that the client 2 could decide to modify the selection threshold defined in the initialisation phase, during the display phase, for example so as to reduce this threshold, in order to give a more detailed reproduction of the scene.

Remember that this type of selection threshold can be defined in many different ways, and in particular it may be evaluated in degrees, projected pixels, size, etc. Thus, the server 3 might only transmit objects that will be seen by the virtual observer at an angle of 1° or more to the client 2, after they have been displayed on the screen of the client terminal 2. In the case of an object associated with a mesh coded by wavelets, the selection threshold may for example be fixed so that it only selects wavelet coefficients inducing a deformation of the mesh greater than or equal to 2°. If the object considered is a sound, the selection threshold may depend on the frequency of this sound or its duration. The selection threshold, and all other selection parameters, may be defined in any other way enabling the server 3 to select relevant objects to be transmitted to the client 2.

Depending on information contained in the context associated with the client 2 (position information, observation direction information, selection parameters, information about the contents of the cache 1), the server 3 transmits objects or data that are visibly relevant to the client 2. This transmission is symbolised by the continuous grey arrow (c) shown in FIG. 3. Determination of visually relevant objects can result from calculations carried out by the server 3, or by another entity of the network 4. It may also have been calculated before the connection between the server 3 and the client 2 is set up, and memorised within the network, for example in the server 3.

Thus, in the particular embodiment shown in FIG. 6, the server 3 determines (63) the object(s) O necessary for the client terminal 2, at an appropriate reproduction level, as a function of some or all of the display information (for example as a function of the position and observation direction information of the client 2 and selection parameters) contained in the context of the client 2.

The server 3 then analyses (64) the list 6 associated with the cache 1 of the client terminal 2, updated as a function of the most recent received updated data, to determine whether or not the object(s) necessary for the client 2 are already stored in the cache 1 of the client 2, in the appropriate refinement level L₀.

If not, the server 3 sends (65) this or these object(s) to the client terminal 2.

According to the invention, an anticipation method can also be implemented enabling the server 3 to transmit (c) objects not yet needed to the client 2, if the server expects that they will become necessary in the near future. For example, if the server 3 determines that the client 2 has moved in the same direction several times, it can transmit (c) to this client 2 an object that is not yet relevant for the client 2, but which will shortly enter the client's field of vision if the client 2 continues to move along the same direction.

At the time of this transmission (c), the server 3 modifies the list 6 associated with the client 2, by adding data transmitted (c) to the client 2 in the form of pairs <O, L₀>, considering that all data transmitted to the client have been stored in the cache 1. This update step is illustrated by step reference 66, in FIG. 6. This type of modification of the list 6 advantageously minimises transmission redundancies. It can happen that some data transmitted (c) by the server 3 to the client 2 are not stored in the cache 1, for example in the case of a transmission error related to the network, which leads to the loss of consistency between the state of the cache 1 and the list 6. Advantageously, the invention comprises a method of overcoming this problem. The consistency between the state of the cache 1 and the list 6 is maintained as described later in more detail with relation to FIG. 8.

We will now describe an example display by the client 2 of three-dimensional models coded by geometric wavelets, with reference to FIGS. 4A to 4C. Remember that “wavelet” coding methods are used to represent a mesh as a succession of details added to a base mesh. The general theory of this technique is described particularly in the article by M. Lounsbery, T. DeRose and J. Warren, “Multiresolution Analysis for Surfaces of Arbitrary Topological Type” (ACM Transaction on Graphics, Vol. 16, No. 1, pp.34-73, January 1997).

As described above, after the client-server dialogue initialisation phase, the server 3 transmits a coarse version called mapping of the base 5 to the client terminal 2. In the case of a base 5 composed of a set of 3D models (shown in FIGS. 4A to 4C), this mapping for example corresponds to a set of values notifying the client terminal 2 about the position and size of different objects of the base 5, for example in the form of the location and the size of the boxes 41A and 42A surrounding these objects.

Depending on the visibility of these objects (in other words as a function of whether they are partially or entirely present in the observer's field of vision, their distance from the observer, etc.), the server 3 then transmits the base mesh 41B, 42B of these objects to the client 2. The client 2 then uses these base meshes 41B, 42B to construct the different sub-caches necessary to it to store data originating from the server 3 and to create a corresponding initial list of pairs <O, L₀>.

In the example in FIGS. 4A to 4C, it is considered that base meshes 41B, 42B each comprises n faces. Therefore the list 6 managed by the server 3 for the client 2 will be composed of a set of pairs <O, <N1, . . . , Nn>> where O represents the object identifier and where Ni represents the number of wavelet coefficients present in the cache 1 for face i of the base mesh 41B, 42B. When the base mesh 41B, 42B is transmitted, the Ni values for i [1,n] are all initialised to zero.

Note that all that the server 3 needs so that it can precisely determine coefficients of wavelets present in the cache 1 of the client 2, is precise knowledge of Ni values for i∈[1,n], provided that a sort order for wavelet coefficients for each of the faces has been determined in advance. Thus, if the client 2 informs the server 3 during step (b) in FIG. 3 that it has 30 coefficients for face No. 8 of the mesh 41B, the server 3 will begin to transmit the coefficients associated with face No. 8 of mesh 41B, and relevant for the client 2, starting from the 31^{st} coefficient. Remember that the selection of relevant coefficients takes account of display information memorised in the client context, such as position information, observation orientation information and selection parameters.

The order in which coefficients are sorted for each mesh face is preferably kept on their arrival in the client terminal 2.

The client terminal 2 can reconstruct a detailed representation 41C, 42C of objects in the scene, starting from coefficients transmitted by the server for each of the visible faces of the base mesh 41B, 41C.

We will now present a second example embodiment of the invention with reference to FIG. 5, for objects using non-progressive detail levels. Unlike the previous example using a wavelet coding technique, in which the objects or portions of objects can be selectively refined as a function of the user's point of view, we will now present the case of an object represented by four successive detail levels references 51 to 54.

As in the example in FIGS. 4A to 4C, the server 3 begins by transmitting mapping of the database 5 to the client 2, that the client 2 will use to know what data should be displayed. The server 3 then transmits the lowest detail level 54 of this object (in other words the coarsest version of the object) to the client 2, for each object in the base 5 that it considers could be visible. During the display, the server 3 will then transmit higher detail levels 53 to 51, depending on the position of the client 2 in the scene. Thus, if the client 2 gradually moves towards the object in FIG. 5, the server 3 will gradually transmit detail levels 53, then 52, then 51, as a function of the distance from the observer to the object.

Coding of the refinement level L₀ associated with the object O will depend on the constraints imposed by the application being used, particularly whether or not it is compulsory that objects should be transmitted in the order of the associated detail levels.

Thus, if the server 3 is obliged to transmit objects to the client 2 in the order of their refinement level, it will be decided to set L₀ equal to the value of the highest detail level present in the cache 1 for the object O. If the cache 1 contains refinement levels references 54 (refinement level 0) and 53 (refinement level 1) for object O, L₀ will be equal to the value “1”. The list 6 will then contain the pair <O, “1”> and the server 3 will deduce that the cache 1 contains refinement levels 0 and 1 for the object O. It will then transmit only the immediately higher detail level to the client 2, if necessary, in other words the level reference 52 corresponding to a refinement level “2”.

If it is not compulsory that the transmission from the server 3 to the client 2 should be made in the order of the refinement levels, L₀ will represent all refinement levels memorised for the object O, in the cache 1 of the client. For example, it may be chosen to code L₀ on several bits, such that the bit for which the position in L₀ corresponds to a detail level memorised in the cache 1 of the client 2, is equal to the value 1. In the example in FIG. 5, if the cache 1 of the client 2 contains refinement levels “0” and “2” corresponding to representation references 54 and 52 respectively, then L₀ will be equal to 0101. The server 3 will then know that it can transmit detail levels 1 and 3, corresponding to representation references 53 and 51 respectively, depending on the position of the user in the scene (particularly his distance from the object considered, and his observation direction).

Similarly, when considering an object with which eight successive detail levels are associated, and if the cache 1 of the client 2 comprises detail levels 1, 2, 4 and 7 for this object, the value of L₀ will be “01001011”. The server 3 will then know that it can transmit levels 3, 5, 6 and 8 to the client 2, based on the display information stored in the associated context.

Note that this type of coding of L₀ is not restricted to 3D objects composed of faces, but it may be applied to any type of data composed of non-progressive detail levels, such as for example multi-resolution textures.

We will now briefly describe a third example embodiment of the invention to the case of sound or video type raw data, or to the case of paginated data (stock management, personnel management, etc.).

For example, in the case of raw sound type data, it may not be necessary for the server 3 to transmit mapping. It can also correspond to the server 3 transmitting a set of data in time, for example informing the client 2 that a violin sound should be played or reproduced within 30 seconds. For this type of sound object, the reproduction information L₀ will for example correspond to the percentage of data transmitted. The value of L₀ will thus enable the server 3 to know for example that the first 15 seconds of a sound lasting for 2 minutes 30 seconds are stored in the cache 1 of the client 2.

In the case of paginated data, mapping sent by the server 3 during the initialisation may for example correspond to the total number of pages existing for each data in the database 5. In this case, the reproduction information L₀ may be variable data in the form <N, N0, . . . , Nn> where N represents the number of pages known for this object (in other words the number of pages stored in the client cache for this object), and where Ni indicates the name of the i^{th} page.

We will now describe the different steps implemented by the client terminal 2 on reception 81 of one or several objects O_{R} sent by the server 3 during the transmission reference (c) in FIG. 3, with reference to FIG. 8. For simplification reasons, we will describe the case in which the server 3 sends a single object O_{R} to the client 2. The technique used in the case in which several objects O_{R} are received by the client 2 and/or the cache 1 will be easily deduced from this case.

During a step reference 82, the client terminal checks the filling ratio of the cache 1 associated with it. If the cache 1 is not integrated in the terminal 2, this check is implemented by the entity responsible for management of the cache 1, for example a proxy server in which the cache 1 is integrated.

If the filling ratio of the cache 1 is less than a predetermined filling threshold, thus indicating that it is possible to store one or several new objects in the cache 1, the received object O_{R} is memorised (83) in the cache 1 of the client 2.

Otherwise, it is not possible to store the object O_{R} received from the server 3 in the cache 1, in its existing state. It will then be determined (84) if there is an object O_{S} in the cache 1, that is visually less relevant than the received object O_{R} for the observer. This type of object Oₛ may be an object that is outside the field of vision of the client 2, for example due to a recent displacement, or a change in the direction of observation of the client 2.

If there is a less relevant object O_{S} of this type, it is deleted (86) from the cache 1, such that the new object O_{R} received from the server 3 can be stored in the cache 1 in its place.

The client terminal 2 then sends (87) information to update the state of the cache 1, to inform the server 3 that this object O_{S} has been deleted from the cache 1, and that the object O_{R} has been correspondingly stored.

On the other hand, if all objects stored in the cache 1 are visually more relevant than the object O_{R} received from the server 3, the entity responsible for managing the cache 1 (for example the client terminal 2) will reject this object O_{R}.

The client terminal 2 then sends (87) an update information about the state of the cache 1, to inform the server 3 that it was impossible to store the object O_{R} in the cache 1.

The server 3 also uses this update information to keep the state of the cache 1 and the list 6 representing its contents consistent. Following reception of this update information, the server 3 can in particular check that all objects that it transmitted to the client 2, and therefore that it added to the list 6, have actually been received with no error by the client 2 and/or the cache 1. In particular, this makes it possible to track transmission problems that could be related to a failure of the network 4.

Therefore, the server 3 compares update information received from the client 2 and the list 6, to check that they are conform and if applicable to update the list as a function of the received update information.

1. A method for transmission of data, called objects, through at least one communication network, between a server and at least one client terminal, at least one cache memory, designed to store at least some of the said objects transmitted by the said server, being associated with at least one of the said client terminals within the said network, the method comprising:
managing at least one list of each object present in the said cache memory associated with one of the said client terminals by the said server or by an intermediate element of the said network, upstream of the said client terminals, in order to limit information exchanges related to the contents of the said cache memory between the said client terminal and the said server.

2. Transmission method according to claim 1, wherein an identifier for each of the said objects is stored within the said list, together with information about reproduction of the said object, for at least one of the said objects.

3. Transmission method according to claim 2, wherein the said reproduction information for at least one of the said objects relates to a refinement level of the said object.

4. Transmission method according to claim 2, wherein the said list comprises a <O, L₀> pair for each of the said objects stored in the said cache memory, including the said O identifier of the said object and the said reproduction information L₀ of the said object.

5. Transmission method as claimed in claim 1, wherein at least one item of information about at least one of the said client terminal and a user of the said client terminal, called the display information, is associated with the said list for each of the said client terminals, so as to form a context.

6. Transmission method according to claim 5, wherein the said display information belongs to the group including:
position information of the said user;
observation direction of the said user; and
selection parameters of the said objects.

7. Transmission method according to claim 5, wherein the method comprises a preliminary initialisation phase, for each of the said client terminals, involving a first transmission step in which initial display information is transmitted to the said server, and a storage step in which the said server stores the said initial display information in the said corresponding context.

8. Transmission method according to claim 7, wherein the said preliminary initialisation phase also comprises a second transmission step in which the said server sends a coarse version of the scene to be reproduced by the said client terminal, to the client terminal.

9. Transmission method as claimed claim 5 wherein each of the said client terminals implements a step to transfer at least some of the said items of display information to the said server at predetermined time intervals and/or when the said display information is modified.

10. Transmission method according to claim 9, wherein the said predetermined time intervals are fixed by the said client terminal.

11. Transmission method according to claim 10, wherein the said predetermined time intervals depend on at least one characteristic of the said communication network.

12. Transmission method according to claim 9, wherein at the end of the said transfer step done by the said client terminal, the said method implements a step to update the said display information within the corresponding said context.

13. Transmission method according to claim 12, wherein at the end of the update step, the said server implements the following steps:
a determination step, as a function of at least some of the said updated display information, to determine at least one identifier object O necessary to the said client terminal, and a corresponding reproduction level L₀;
a step to analyse the said list representative of the said cache memory associated with the said client terminal, so as to identify pairs <O, L₀>, if any, corresponding to the said identifier object(s) O and reproduction level L₀ necessary to the said client terminal, and not memorised in the said list;
a step to transmit the said identifier object(s) O, if any, with reproduction level L₀ that the said client terminal needs, corresponding to any of the said pair(s) <O, L₀> not memorised in the said list, to the said client terminal; and
a step (66) to update the said list representative of the said cache memory associated with the said client terminal, adding the said pair(s) <O, L₀> corresponding to the said object(s) sent, if any, to the said client terminal.

14. Transmission method according to claim 13, wherein the said server also implements:
a step to determine at least one identifier object O and reproduction level L₀ that may be necessary to the said client terminal, according to at least one predetermined probability criterion; and
a step in which the said at least one identifier object O and reproduction level L₀ is sent to the said client terminal in anticipation.

15. Transmission method according to claim 13, wherein on reception of at least one object sent by the said server, the said client terminal performs the following steps:
a step for storage of the said received object in the said cache memory if the filling ratio of the said cache memory associated with the said client terminal is less than a predetermined threshold;
otherwise, a step for evaluation of a relevance criterion for the said received object:
if at least one of the said objects stored in the said cache memory has a relevance criterion with a value less than the said relevance criterion of the said received object, the said client terminal implements a sub-step to delete the said less relevant object from the said cache memory and a sub-step for storage of the said received object in the said cache memory;
otherwise, the said client terminal implements a sub-step to reject the said received object.

16. Transmission method according to claim 15, wherein after the said deletion sub-step and/or the said rejection sub-step, the said client terminal sends at least one item of information to update the said cache memory associated with the said client terminal to the said server, so that the said server eliminates at least one <O, L₀> pair corresponding to the said object deleted during the said deletion sub-step, and/or an object sent by the said server during the said transmission step, but not memorised in the said cache memory, from the said list representative of the said cache memory.

17. Transmission method as claimed in claim 1, wherein at least some of the said objects comprise at least one index, so as to be able to selectively transmit a portion of the said object starting from the said associated index.

18. A system for transmission of data, called objects, through at least one communication network, between a server and at least one client terminal, the system comprising:
at least one cache memory, designed to store at least some of the said objects transmitted by the said server, and being associated with at least one of the said client terminals within the said network, and
means, upstream of the said client terminals, for managing at least one list of each of the objects present in the said cache memory associated with one of the said client terminals, in order to limit information exchanges related to the contents of the said cache memory between the said client terminal and the said server.

19. A data server, for data called objects, connected through at least one communication network to at least one client terminal, the data server comprising:
at least one cache memory, designed to store at least some of the said objects transmitted by the said server, and being associated with at least one of the said client terminals within the said network, and
means of management of at least one list of each of the objects present in the said cache memory associated with at least one of the said client terminals, in order to limit information exchanges with the said associated client terminal, for information related to the contents of the said cache memory.

20. A client terminal for a data server according to claim 19, wherein the client terminal comprises means of transmission of at least one item of update information to the said server so as to enable the said server to update the said representative list of the said cache memory associated with the said terminal.
